(19) United States
(12) Patent Application Publication
(10) Pub. No.: US 2014/0234466 A1
(43) Pub. Date: Aug. 21, 2014

(54) IMPRINT MOLD AND METHOD FOR MAKING USING SIDEWALL SPACER LINE DOUBLING

(71) Applicant: HGST NETHERLANDS B.V., Amsterdam (NL)

(72) Inventors: He Gao, San Jose, CA (US); Jeffrey S. Lille, Sunnyvale, CA (US); Lei Wan, San Jose, CA (US)

(73) Assignee: HGST NETHERLANDS B.V., Amsterdam (NL)

(21) Appl. No.: 13/772,642

(22) Filed: Feb. 21, 2013

(51) Int. Cl. B29C 59/00

(52) U.S. Cl. CPC B29C 59/002
USPC 425/385; 216/39

(57) ABSTRACT

A method for making an imprint mold uses sidewall spacer line doubling, but without the need to transfer the sidewall spacer patterns into the mold substrate. A base layer is deposited on the mold substrate, followed by deposition and patterning of a mandrel layer into stripes with tops and sidewalls. A layer of spacer material is deposited on the tops and sidewalls of the mandrel stripes and on the base layer between the mandrel stripes. The spacer material on the tops of the mandrel stripes and on the base layer between the mandrel stripes is then removed. The mandrel stripes are then etched away, leaving stripes of sidewall spacer material on the base layer. The resulting mold is a substrate with pillars of sidewall spacer material patterned as stripes and extending from the substrate, with the sidewall spacers serving as the mold features for imprinting.

### BACKGROUND OF THE INVENTION

1. Field of the Invention

This invention relates to a mold to be used for imprinting and to a method for making the mold. Imprint molds can be used to imprint a master template that is then used to imprint patterned-media magnetic recording disks, and have also been proposed for use in the manufacturing of semiconductor devices, such as DRAM and NAND flash devices.

2. Description of the Related Art

Magnetic recording hard disk drives with patterned magnetic recording media have been proposed to increase data density. In patterned media, the magnetic recording layer on the disk is patterned into small isolated data islands arranged in concentric data tracks. The proposed patterned-media disks are likely to be perpendicular magnetic recording disks, wherein the magnetization directions are perpendicular to or out-of-the-plane of the recording layer on the data islands.

One proposed method for fabricating patterned-media disks is by imprinting with a master disk or template, sometimes also called a “stamper”, that has a topographic surface pattern. In this method the magnetic recording disk with a polymer film on its surface is pressed against the template. In one type of patterned media, the magnetic layers and other layers needed for the magnetic recording disk are first deposited on the flat disk substrate. The polymer film is formed on top of these layers. The polymer film receives the reverse image of the template pattern and then becomes a mask for subsequent milling, etching or ion-bombarding the underlying layers to leave discrete islands of magnetic recording material. In another type of patterned media the disk substrate with a polymer film on its surface is pressed against the template. The polymer film receives the reverse image of the template pattern and then becomes a mask for subsequent etching of the disk substrate to form pillars on the disk substrate. Then the magnetic layer and other layers needed for the magnetic recording disk are deposited onto the etched disk substrate and the tops of the pillars to form the patterned-media disk.

However, it is difficult to make the master template with the desired small features, typically in the range of 10-30 nm. Pending application Ser. No. 13/627,492, filed Sep. 26, 2012 and assigned to the same assignee as this invention, describes the use of two imprint molds, one with a pattern of generally radial spokes or lines, and the other with generally concentric circular rings, to make the master template by two separate imprinting steps with the two molds. Because of the small nano-sized features, the imprinting method is sometimes referred to as “nanoimprinting” and the imprint molds and templates are sometimes referred to as “nanoimprint” molds and templates.

Imprint molds have also been proposed for use in semiconductor manufacturing. For example, imprint molds can be used to pattern parallel generally straight lines in DRAM and NAND flash devices.

What is needed is an improved imprint mold, and method for making it.

### SUMMARY OF THE INVENTION

The invention relates to a method for making an imprint mold. The imprint mold can then be used to make a master template which can then be used for imprinting patterned-media magnetic recording disks. The method uses sidewall spacer line doubling, but without the need to transfer the sidewall spacer patterns further into the underlying mold substrate. An etch-resistant base layer is deposited on the planar surface of the mold substrate, followed by deposition and subsequent patterning of a mandrel layer, such as a layer of diamond-like carbon (DLC). The mandrel layer is patterned into a plurality of stripes with tops and sidewalls. A layer of spacer material, such as a layer of titanium dioxide, is deposited, preferably by atomic layer deposition (ALD), on the tops and sidewalls of the mandrel stripes and on the base layer between the mandrel stripes. The spacer material on the tops of the mandrel stripes and on the base layer between the mandrel stripes is then removed by anisotropic etching, leaving the mandrel stripes and sidewall spacer material. Then the mandrel stripes are etched away, leaving stripes of sidewall spacer material on the base layer as the imprint mold features. An optional conformal layer of silicon dioxide may deposited, preferably by ALD, over the sidewall spacer stripes and the base layer between the sidewall spacer stripes.

The resulting mold thus has a planar substrate with pillars of sidewall spacer material patterned as stripes and extending from the substrate's planar surface, with the sidewall spacers serving as the mold features for imprinting. A first mold has pillars of sidewall spacer stripes patterned as generally radial lines and a second mold has pillars of sidewall spacer stripes patterned as generally concentric circular rings. The two molds are then used in a two-step process to imprint a resist layer on the master template substrate. The patterned resist is then used as a mask to etch the master template substrate with the desired pattern of pillars corresponding to the pattern of data islands in the magnetic recording disks to be imprinted by the template or its replicas.

For a fuller understanding of the nature and advantages of the present invention, reference should be made to the following detailed description taken together with the accompanying figures.

### BRIEF DESCRIPTION OF THE DRAWING

FIG. 1 is a top view of a disk drive with a patterned-media type of magnetic recording disk as described in the prior art.

FIG. 2 is a top view of an enlarged portion of a patterned-media type of magnetic recording disk showing the detailed arrangement of the data islands in one of the bands on the surface of the disk substrate.

FIGS. 3A-3C are sectional views illustrating the general concept of imprinting according to the prior art.

FIGS. 4A-4F illustrate the method for making the imprint mold according to the invention.

FIG. 4G is a scanning electron microscopy (SEM) image of a top view of a section of the mold depicted in FIG. 4F.

FIG. 5A is a sectional view depicting the mold according to the invention after imprinting a resist layer on the master template substrate.

FIG. 5B is SEM image of a top view of a section of the imprint resist on a quartz substrate after imprinting with the mold according to this invention.

### DETAILED DESCRIPTION OF THE INVENTION

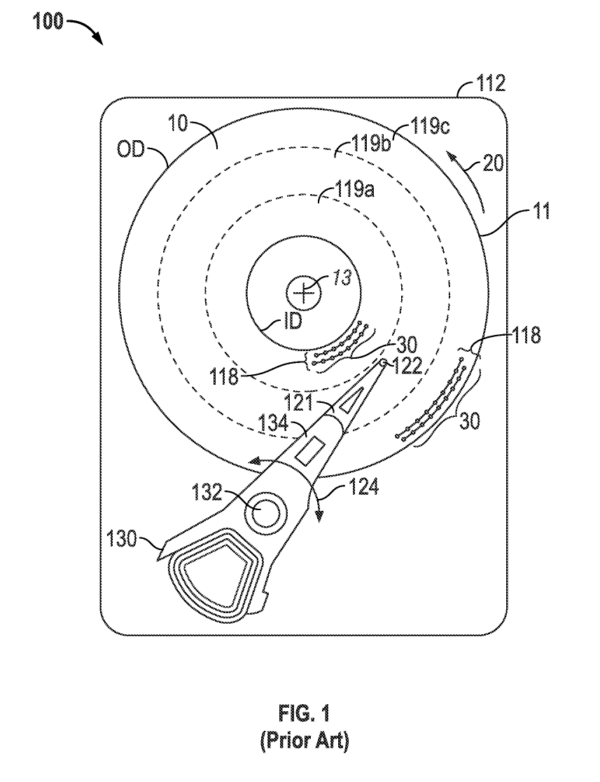

FIG. 1 is a top view of a disk drive 100 with a patterned magnetic recording disk 10 as described in the prior art. The drive 100 has a housing or base 112 that supports an actuator 130 and a drive motor for rotating the magnetic recording disk 10 about its center 13. The actuator 130 may be a voice coil motor (VCM) rotary actuator that has a rigid arm 134 and rotates about pivot 132 as shown by arrow 124. A head-suspension assembly includes a suspension 121 that has one end attached to the end of actuator arm 134 and a head carrier 122, such as an air-bearing slider, attached to the other end of suspension 121. The suspension 121 permits the head carrier 122 to be maintained very close to the surface of disk 10. A magnetoresistive read head (not shown) and an inductive write head (not shown) are typically formed as an integrated read/write head patterned on the trailing surface of the head carrier 122, as is well known in the art.

The patterned magnetic recording disk 10 includes a disk substrate 11 and discrete data islands 30 of magnetizable material on the substrate 11. The data islands 30 function as discrete magnetic bits for the storage of data and are arranged in radially-spaced circular tracks 118, with the tracks 118 being grouped into annular bands 119a, 119b, 119c. The grouping of the data tracks into annular zones or bands permits banded recording, wherein the angular spacing of the data islands, and thus the data rate, is different in each band. In FIG. 1, only a few islands 30 and representative tracks 118 are shown in the inner band 119a and the outer band 119c. As the disk 10 rotates about its center 13 in the direction of arrow 20, the movement of actuator 130 allows the read/write head on the trailing end of head carrier 122 to access different data tracks 118 on disk 10. Rotation of the actuator 130 about pivot 132 to cause the read/write head on the trailing end of head carrier 122 to move from near the disk inside diameter (ID) to near the disk outside diameter (OD) will result in the read/write head making an arcuate path across the disk 10.

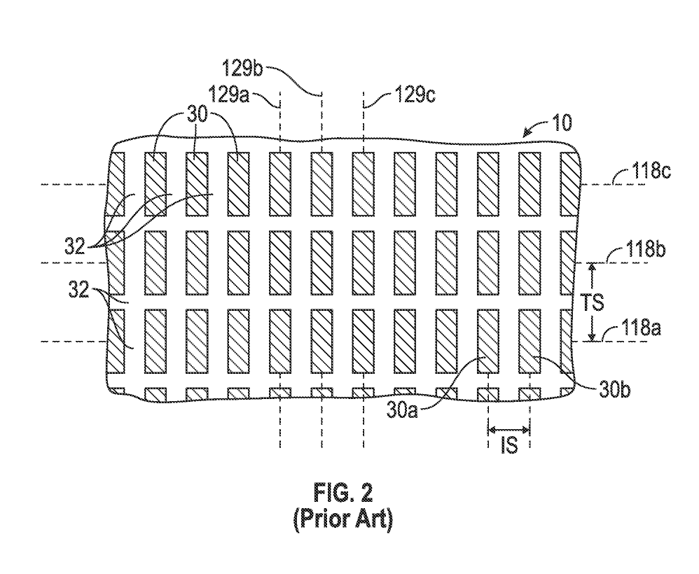

FIG. 2 is a top view of an enlarged portion of disk 10 showing the detailed arrangement of the data islands 30 separated by nonmagnetic regions 32 in one of the bands on the surface of disk substrate 11 according to the prior art. The islands 30 are shown as being generally rectangularly shaped. The islands 30 contain magnetizable recording material and are arranged in tracks spaced-apart in the radial or cross-track direction, as shown by tracks 118a-118c. The tracks are typically spaced apart by a nearly fixed track pitch or spacing TS. Within each track 118a-118c, the islands 30 are roughly equally spaced apart by a nearly fixed along-the-track island pitch or spacing IS, as shown by typical islands 30a, 30b, where IS is the spacing between the centers of two adjacent islands in a track.

The bit-aspect-ratio (BAR) of the pattern of discrete data islands arranged in concentric tracks is the ratio of track spacing or pitch in the radial or cross-track direction to the island spacing or pitch in the circumferential or along-the-track direction. This is the same as the ratio of linear island density in bits per inch (BPI) in the along-the-track direction to the track density in tracks per inch (TPI) in the cross-track direction. In the example of FIG. 2, TS is approximately twice IS, so the BAR is approximately 2.

The islands 30 are also arranged into generally radial spokes or lines, as shown by radial lines 129a, 129b and 129c that extend from disk center 13 (FIG. 1). Because FIG. 2 shows only a very small portion of the disk substrate 11 with only a few of the data islands, the pattern of islands 30 appears to be two sets of perpendicular lines. However, tracks 118a-118c are concentric circular rings centered about the center 13 of disk 10 and the lines 129a, 129b, 129c are not parallel lines, but radial lines extending from the center 13 of disk 10. Thus the angular spacing between adjacent islands as measured from the center 13 of the disk for adjacent islands in lines 129a and 129b in a radially inner track (like track 118c) of a zone is the same as the angular spacing for adjacent islands in lines 129a and 129b in a radially outer track (like track 118a) of the zone.

The generally radial spokes or lines (like lines 129a, 129b, 129c) may be perfectly straight radial lines but are preferably arcs or arcuate-shaped radial lines that replicate the arcuate path of the read/write head on the rotary actuator. Such arcuate-shaped radial lines provide a constant phase position of the data islands as the head sweeps across the data tracks. There is a very small radial offset between the read head and the write head, so that the synchronization field used for writing on a track is actually read from a different track. If the islands between the two tracks are in phase, which is the case if the radial lines are arcuate-shaped, then writing is greatly simplified.

Patterned-media disks like that shown in FIG. 2 may be longitudinal magnetic recording disks, wherein the magnetization directions in the magnetizable recording material are parallel to or in the plane of the recording layer in the islands, but are more likely to be perpendicular magnetic recording disks, wherein the magnetization directions are perpendicular to or out-of-the-plane of the recording layer in the islands.

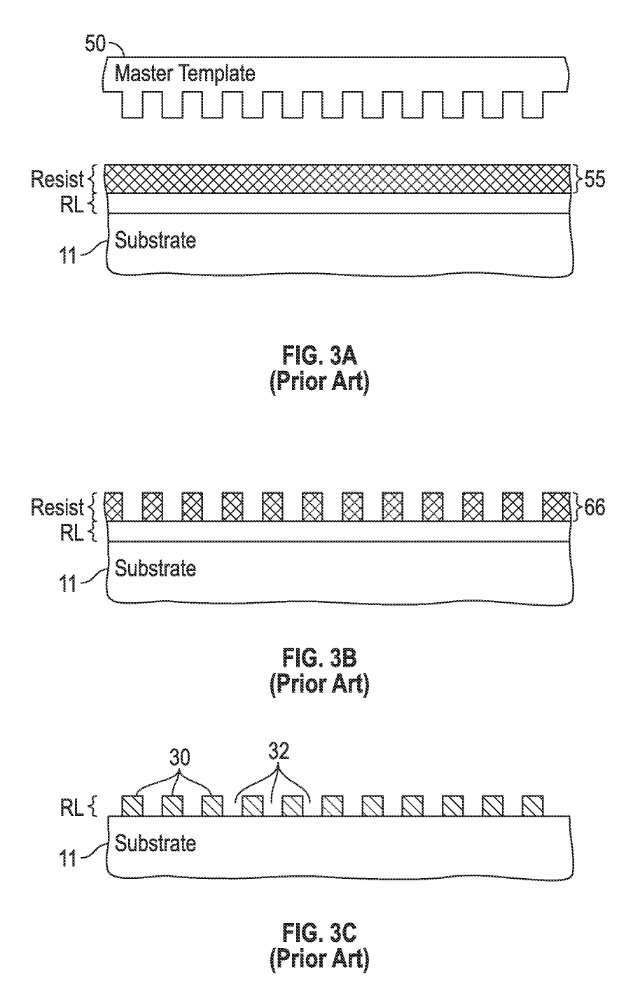

One proposed technique for fabricating patterned magnetic recording disks is by imprinting using a master template. FIGS. 3A-3C are sectional views illustrating the general concept of imprinting. FIG. 3A is a sectional view showing the disk according to the prior art before lithographic patterning and etching to form the data islands. The disk has a substrate 11 supporting a recording layer (RL) having perpendicular (i.e., generally perpendicular to substrate surface) magnetic anisotropy. A layer of imprint resist 55 is formed on the RL. The structure of FIG. 3A is then lithographically patterned by imprinting with a UV-transparent template 50 that has the desired pattern of data islands. In the prior art the template 50 is typically a fused quartz substrate that has been etched away in different etching steps to form the desired pattern. The template 50 with its predefined pattern is brought into contact with the liquid imprint resist layer, which is a UV-curable polymer, and the template 50 and disk are pressed together. UV light is then transmitted through the transparent template 50 to cure the liquid imprint resist. After the resist has hardened the template is removed, leaving the inverse pattern of the template on the hardened resist layer. The template is separated from the disk and the patterned imprint resist 66 is left. The resulting structure is shown in FIG. 3B. The patterned imprint resist 66 is then used as an etch mask. Reactive-ion-etching (RIE) can be used to transfer the pattern from the imprint resist to the underlying RL. The imprint resist is then removed, leaving the resulting structure of data islands 30 of RL material separated by nonmagnetic regions 32, as shown in FIG. 3C. FIGS. 3A-3C are highly schematic representations merely to illustrate the general imprinting process. The disk would typically include additional layers below the RL. Also the structure of FIG. 3C would typically then be planarized with fill material in the nonmagnetic regions 32, followed by deposition of a protective overcoat and liquid lubricant.

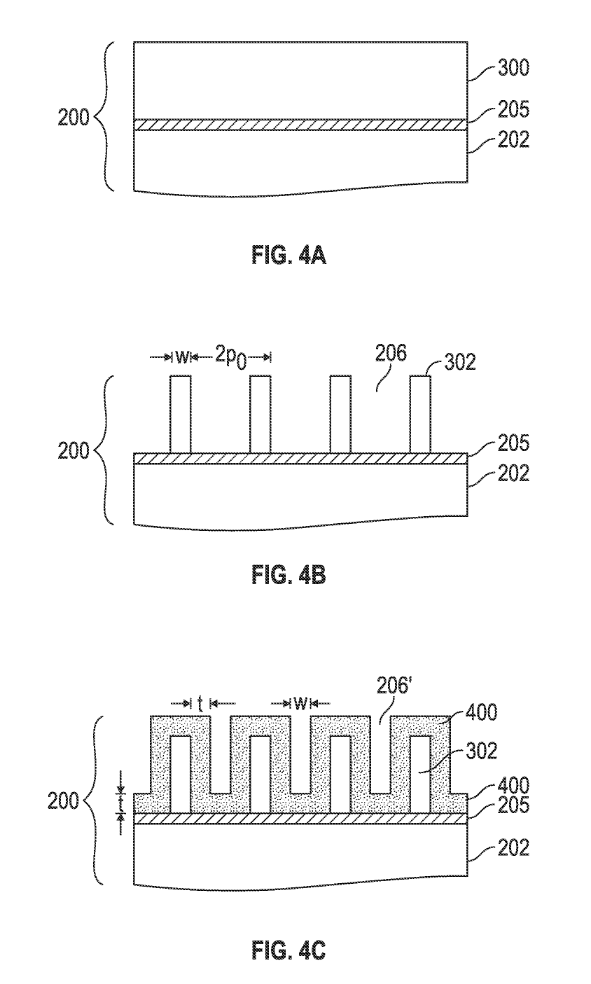

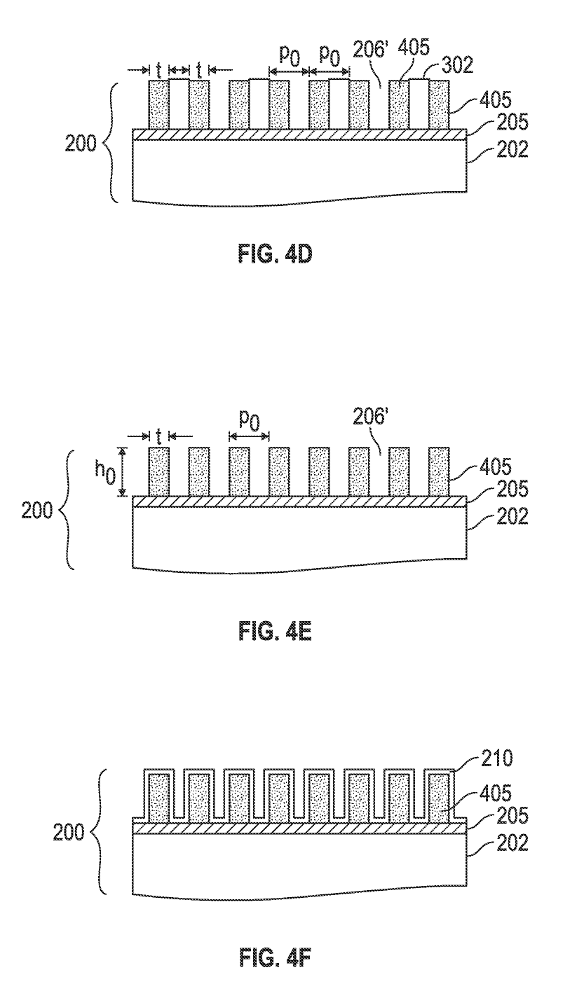

This invention is an improved imprint mold that is used to make the master template with the desired pattern of data islands and to a method for making the mold. The method uses sidewall spacer line doubling, but without the need to transfer the sidewall spacer patterns into the underlying mold substrate. Sidewall spacer line doubling is known for making imprint molds, but the sidewall spacers are used as an etch mask to etch into the underlying substrate or a hard mask layer, after which the sidewall spacer material is removed. The mold according to this invention thus has a planar substrate with pillars of sidewall spacer material patterned as stripes and extending from the substrate's planar surface, with the sidewall spacers serving as the mold features for imprinting. The mold according to the invention and the method for making it will be described with FIGS. 4A-4G.

Referring to FIG. 4A, the fabrication of mold 200 starts with a planar substrate 202 which may be, but is not limited to, a Si wafer, a fused silica wafer or fused quartz, and which may also be coated with materials such as silicon nitride, carbon, tantalum, molybdenum, chromium, alumina or sapphire. An etch-resistant base layer 205 of a material that is resistant to at least one of the common etch chemistries, such as fluorine-containing reactive ion etching (RIE), chlorine-containing RIE, or acid or base wet etch, is deposited onto the planar surface of substrate 200. The top planar surface of base layer 205 defines a common base plane of all features that will be patterned in subsequent steps. The material of base layer 205 can be, but is not limited to, Cr, Pd, Rh or alloys thereof. The thickness of the base layer 205 is typically at least 1 nm and preferably in the range of 1-20 nm. A first optional adhesion layer (not shown) of Ta, Ti, Cr of about 1 nm may be deposited on top of the substrate 200 to facilitate the adhesion of base layer 205. A mandrel layer 300 is deposited on base layer 205. The material of the mandrel layer 300 is preferably diamond-like carbon (DLC), but can also can be a resist, a polymer, or a block copolymer. The thickness of the mandrel layer 300 is typically between 1 and 3 three times h₀, where h₀ is final mold pattern depth (i.e., the desired final height of the mold imprint features). A second optional adhesion layer (not shown) of Si or a silicon nitride (SiNx) with a thickness of about 1 nm, or a common adhesion promoter such as hexamethyldisilazane (HMDS), may be deposited on top of the base layer 205 to facilitate adhesion of the subsequently deposited mandrel layer 300. If the material of the mandrel layer 300 is not a resist or block copolymer, additional layers of materials (not shown), such as a resist or block copolymer and/or a hardmask material such as SiO₂ or SiNx, may be deposited on top of the mandrel layer 300 for the initial patterning to allow the lithography and transfer etching into the mandrel layer 300 in the next step. In the present example described herein the substrate 202 is single-crystal semiconductor Si, the base layer 205 is 4 nm of Cr, and the mandrel layer 300 is 30 nm of diamond-like carbon (DLC). A 1 nm thick film of Si is on top of Cr base layer 205 to facilitate adhesion of the DLC on the Cr. The desired final mold pattern depth h₀ is 16 nm.

In FIG. 4B the mandrel layer 300 is patterned into periodic stripes 302. The patterning of the mandrel stripes 302 may be achieved using e-beam lithography, optical lithography, imprint lithography, directed self assembly of block copolymers, a spatial line frequency doubling process, or a combination thereof, and related etch techniques. The pitch of the periodic stripes 302 in the direction parallel to the substrate surface and orthogonal to the stripes, is 2p₀, i.e., two times the final pitch of the final mold features. If the mold features are to be generally concentric circular rings the pitch is the radial dimension between the rings; if the mold features are to be generally radial spokes the pitch is the average circumferential spacing between the spokes. The width (w) of the stripes 302 must be less than the final pitch p₀ of the mold patterns. The choice of the width (w) is typically close to p₀/2, i.e., half of the final pitch of the mold patterns. After patterning of the mandrel stripes 302, portions of the underlying base layer 205 are exposed in the spaces or gaps 206 between the stripes 302. The width of the gaps 206 at this step is 2p₀−w, the difference between two times the final pitch p₀ of the mold patterns and the stripe width w. In the present example, the desired final pitch of the mold pattern is approximately 20 nm, and therefore the pitch of the mandrel stripes 302 is 40 nm. The width w of the mandrel stripes 302 is approximately 13 nm. The initial patterning of the DLC mandrel layer 300 is done using e-beam directed self-assembly of a block copolymer polystyrene-block-polymethylmethacrylate (PS-b-PMMA), followed by etching into the DLC.

In the next step, shown in FIG. 4C, a layer of spacer material 400 is deposited in a conformal manner, on the top and sidewalls of stripes 302, as well as on the portions of the base layer in gaps 206, with a uniform thickness t. The thickness t is chosen to be pₒ-w, the difference between the final pitch of the mold patterns and the width of the stripes 302. At this step, the width of the gaps 206′ is reduced to approximately w, the same as the width of the stripes 302. The spacer material 400 is preferably a titanium oxide (TiOx), such as essentially titanium dioxide (TiO₂), but may also be, but not limited to, an aluminum oxide (AlOx), HfO₂, a silicon oxide (SiOx), a silicon nitride (SiNx), a tantalum nitride (TaNx), and Si, Mo or Ta. The deposition method may be physical vapor deposition (PVD), chemical vapor deposition (CVD), or atomic layer deposition (ALD).

In the present example, the spacer material 400 is a TiOx which consists essentially of titanium dioxide (TiO₂), and is deposited using thermal ALD. The ALD process is well known but generally described as a thin film deposition technique that is based on the sequential use of a gas phase chemical process, in which by repeatedly exposing gas phase chemicals known as the precursors to the growth surface and activating them at elevated temperature, with or without the assistance from a plasma or ozone, a precisely controlled thin film is deposited in a conformal manner. The precursors used in the present example for TiOx deposition are tetrakis(dimethylamido)titanium (TDMAT) and water vapor and the ALD is carried out with the substrate heated to 250° C. without using a plasma or ozone. It has been discovered that if the mandrel stripes are DLC, a conformal coating of a titanium oxide (TiOx) spacer material over the DLC occurs without damage to the DLC stripes if thermal ALD is used without the assistance of plasma or ozone. However, if either plasma or ozone is involved during the deposition of the TiOx spacer material, the narrow DLC stripes may be damaged. Thus in the process of this invention the preferred method of deposition of TiOx on DLC stripes is by thermal ALD without the use of plasma or ozone. Alternatively, other titanium-containing precursors could be used in conjunction with water, such as titanium tetrachloride (TiCl₄), and titanium butoxide (Ti(OBu)₄). The thickness t of the TiOx layer formed by ALD is approximately 7 nm.

Next, as shown in FIG. 4D, an anisotropic etch in a direction perpendicular to the substrate surface is carried out to etch back the spacer material 400. The etch-back of the spacer material 400 can be done using reactive ion etching (RIE) with an etchant gas containing fluorine and/or chlorine or by ion beam (Ar) etching. The height of the mandrel stripes 302 may also be shortened by the etch chemistry or ion bombardment. The vertical thickness of the spacer material 400 to be removed by the etch step should be at least t, the initial layer thickness of the spacer material 400. This will ensure the removal of the spacer material on top of mandrel stripes 302, and in the narrowed gaps 206′, leaving only stripes 405 of spacer material covering the sidewalls of mandrel stripes 302. The stripes 405 are known as the sidewall spacers. The lateral width of the sidewall spacers 405 is t, the as-deposited thickness of the spacer material 400. The sidewall spacers 405 have a pitch of p₀, the final pitch of the mold patterns. The etch step will typically continue until the height of the sidewall spacers 405 is close to h₀. In the present example, the etch process is a fluorine containing RIE process, and the resulting height of the TiOx sidewall spacers 405 is approximately 16 nm.

The remaining mandrel stripes 302 are subsequently removed using RIE or wet etch. In the resulting structure shown in FIG. 4E, only sidewall spacers 405 of pitch p₀ and width t are left on top of the base layer 205. Further etching of the sidewall spacers 405 may be performed to decrease the height of the sidewall spacers to a desired value. In the present example the DLC mandrel stripes 302 are removed using a H₂ and Ar RIE, followed by O₂ RIE. The sidewall spacer method described above results in line doubling, i.e., the number of stripes of sidewall spacers 405 in FIG. 4E is double the number of mandrel stripes 302 in FIG. 4B.

In FIG. 4F, the sidewall spacer defined imprint mold 200 is completed with an optional conformal layer 210. Conformal layer 210 is preferably a 0.5-5 nm thick film of SiO₂. The conformal layer 210 ensures a consistent surface property suitable for imprint lithography. In the present example, approximately 1 nm of SiO₂ is deposited by ALD using the tris[dimethylamino]silane (3DMAS) precursor assisted by oxygen plasma. Alternatively, other silicon-containing precursors could be used, such as tetrakis(dimethylamino)silane (TDMAS) and tetrachlorosilane (SiCl₄). The silicon dioxide film 210 further protects the base layer gaps 206′ and the TiOx sidewall spacers against template cleaning agents such as a solution of ammonium hydroxide, hydrogen peroxide and water, and a solution of sulfuric acid and hydrogen peroxide. This also provides an advantage because silicon dioxide is known to work well with releasing agents, allowing good release properties from the resist after imprinting of the resist on the master template. The mold may undergo many cleaning and reconditioning steps during use to preserve its critical dimensions, for example between 10 to 100 times. Additionally, the silicon dioxide film 210 can be replenished by ALD when the film 210 has been damaged or thinned down by the cleaning agents after template cleaning and reconditioning.

FIG. 4G is a scanning electron microscopy (SEM) image of a top view of a section of the mold depicted in FIG. 4F. The lighter lines are the SiO₂ layer 210 coated on top of the TiOx sidewall spacers 405. The pitch of the sidewall spacers is approximately 20 nm.

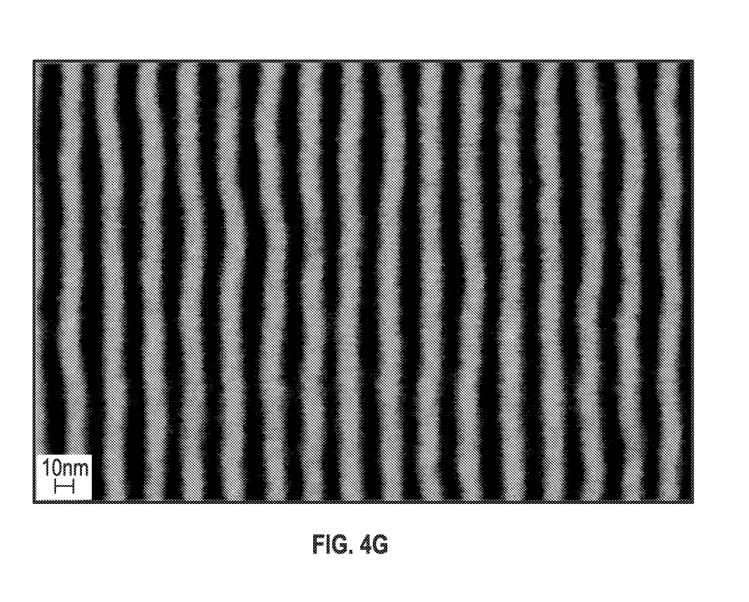

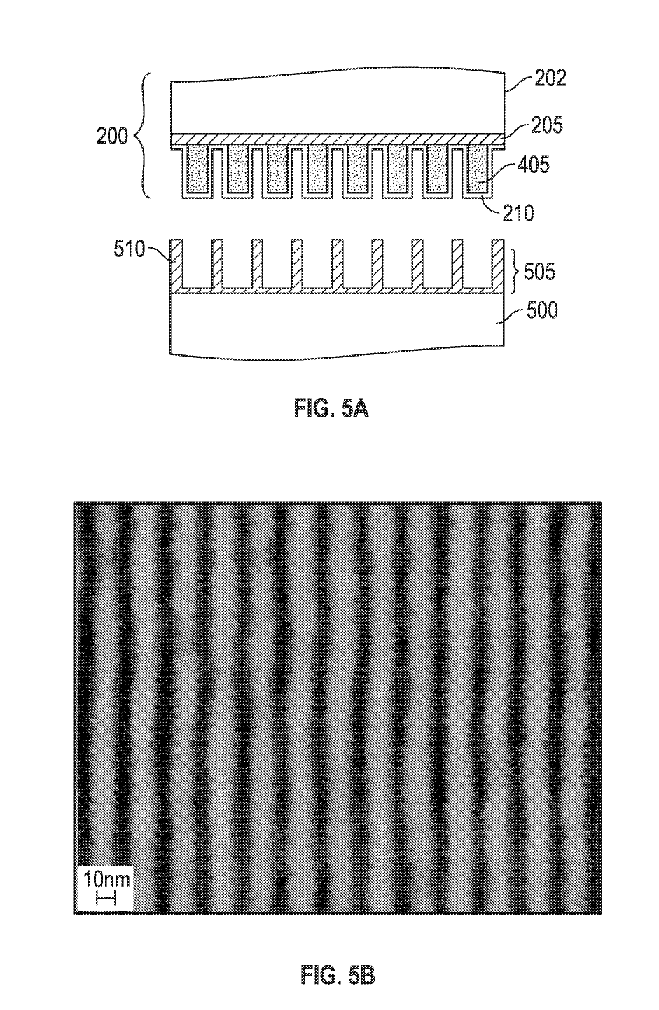

As shown in FIG. 5A, the sidewall spacer defined imprint mold 200 is used in imprint lithography to press the patterns of sidewall spacers 405 into a resist layer 505 on a substrate 500. If the substrate 500 is to be a semiconductor device the sidewall spacers 405 are stripes of pillars patterned as parallel generally straight lines. If the substrate 500 will ultimately become the master template for imprinting patterned-media magnetic recording disks, the sidewall spacers 405 are stripes of pillars extending from the mold substrate 202 and are patterned either as generally radial spokes or generally concentric circular rings. After the curing of the resist 505, the mold 200 is separated from the resist 505 and substrate 500, leaving stripes 510 in the resist layer 505 that are the reverse image of the mold patterns. In the present example, the resist 505 is a UV curable and the substrate 500 is a quartz wafer. The UV light shines through the quartz wafer to cure the resist 505 before the separation of the mold 200. A top view SEM image of a section of the imprint resist 505 on quartz substrate 500 is shown in FIG. 5B. The bright lines are the resist stripes 510 with a 20 nm pitch (coated with a thin layer of metal to enable SEM imaging).

FIGS. 5A and 5B thus show the master template substrate 500 with a first set of resist stripes 510 after imprinting with a first mold having the pillars of sidewall spacers patterned with one of either generally radial spokes or generally concentric circular rings. Then a second layer of resist is deposited over the first set of resist stripes 510 and the substrate 500 is imprinted with a second mold having sidewall spacers patterned with the other of either generally radial spokes or generally concentric circular rings. After a second UV curing step and removal of the second mold, the template substrate 500 will have a layer of resist patterned with pillars that is identical to the pattern of data islands shown in FIG. 2, i.e., the pillars of resist will be patterned into generally radial lines and concentric circular rings. This resist pattern is then used as an etch mask to etch into the master template substrate. The resist is then removed, leaving the master template substrate with a pattern of pillars for imprinting the magnetic recording disks.

The stripes 302 may be patterned as generally parallel stripes if the resulting etched substrate is to be used in a semiconductor device.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A method for making an imprint mold having a planar substrate and imprinting features extending from the planar substrate and formed of material different from the substrate, the method comprising:
providing a planar substrate;
depositing on the planar substrate an etch-resistant base layer;
depositing on the base layer an etchable mandrel layer;
patterning the mandrel layer into a plurality of stripes on the base layer, the mandrel stripes having tops and sidewalls;
depositing a layer of spacer material on the tops and sidewalls of the mandrel stripes and on the base layer between the mandrel stripes;
etching away the spacer material on the tops of the mandrel stripes and on the base layer between the mandrel stripes, leaving the mandrel stripes and sidewall spacer material; and
etching away the mandrel stripes, leaving stripes of sidewall spacer material on the base layer as the imprint mold features.

2. The method of claim 1 further comprising depositing a film of silicon dioxide over the sidewall spacer stripes and the base layer between the sidewall spacer stripes.

3. The method of claim 1 wherein depositing a layer of spacer material on the tops and sidewalls of the mandrel stripes and on the base layer between the mandrel stripes comprises depositing a layer of material selected from a titanium oxide (TiOx), an aluminum oxide (AlOx), HfO₂, a silicon oxide (SiOx), a silicon nitride (SiNx), Si, Mo and Ta.

4. The method of claim 3 wherein depositing a layer of spacer material on the tops and sidewalls of the mandrel stripes and on the base layer between the mandrel stripes comprises depositing a layer of TiOx by atomic layer deposition (ALD).

5. The method of claim 4 wherein the mandrel layer is diamond-like carbon (DLC) and wherein depositing a layer of TiOx by ALD comprises depositing the TiOx by ALD while the substrate is heated to a temperature between 100 and 300° C. without the assistance of a plasma and without the assistance of oxygen.

6. The method of claim 1 wherein the etch-resistant base layer is selected from Cr, Pd, Rh and alloys thereof.

7. The method of claim 1 further comprising depositing a first adhesion layer on the substrate layer before depositing the base layer.

8. The method of claim 1 further comprising depositing a second adhesion layer on the base layer before depositing the mandrel layer.

9. The method of claim 1 wherein etching away the spacer material on the tops of the mandrel stripes and on the etch-resistant base layer between the mandrel stripes comprises etching by one of Ar ion beam etching and reactive ion etching (RIE) with an etchant gas containing one or both of fluorine and chlorine.

10. The method of claim 1 wherein etching away the mandrel stripes comprises etching by reactive ion etching (RIE) with an etchant gas containing one or both of oxygen and hydrogen.

11. The method of claim 1 wherein patterning the mandrel layer into a plurality of stripes comprises patterning the mandrel layer into a pattern of generally radial spokes, whereby etching away the mandrel stripes leaves stripes of sidewall spacer material in a pattern of generally radial spokes.

12. The method of claim 1 wherein patterning the mandrel layer into a plurality of stripes comprises patterning the mandrel layer into a pattern of generally concentric circular rings, whereby etching away the mandrel stripes leaves stripes of sidewall spacer material in a pattern of generally concentric circular rings.

13. The method of claim 1 wherein patterning the mandrel layer into a plurality of stripes comprises patterning the mandrel layer into a pattern of parallel generally straight lines, whereby etching away the mandrel stripes leaves stripes of sidewall spacer material in a pattern of parallel generally straight lines.

14. The method of claim 1 wherein the mandrel stripes have a pitch in a direction parallel to the substrate and orthogonal to the mandrel stripes of 2p₀ and the sidewall spacer stripes have a pitch in a direction parallel to the substrate and orthogonal to the sidewall spacer stripes of p₀.

15. The method of claim 1 wherein the mandrel stripes have a width w, and wherein depositing a layer of spacer material comprises depositing the spacer material to a thickness t, wherein t is approximately equal to p₀−w.

16. A method for making an imprint mold having a planar substrate and imprinting features extending from the planar substrate, the method comprising:
providing a planar substrate;
depositing on the planar substrate an etch-resistant base layer;
depositing on the base layer a diamond-like carbon (DLC) layer;
patterning the DLC layer into a plurality of stripes on the base layer, the DLC stripes having tops and sidewalls;
depositing, by atomic layer deposition, a titanium oxide spacer layer on the tops and sidewalls of the DLC stripes and on the base layer between the DLC stripes;
etching away the spacer layer on the tops of the DLC stripes and on the base layer between the DLC stripes, leaving the DLC stripes and sidewall spacers;
etching away the DLC stripes, leaving stripes of sidewall spacers on the base layer as the imprint mold features; and
depositing a conformal film of silicon dioxide over the sidewall spacer stripes and the base layer between the sidewall spacer stripes.

17. The method of claim 16 wherein the etch-resistant base layer is selected from Cr, Pd, Rh and alloys thereof.

18. The method of claim 16 further comprising depositing a first adhesion layer on the substrate layer before depositing the base layer.

19. The method of claim 16 further comprising depositing a second adhesion layer on the base layer before depositing the DLC layer.

20. The method of claim 16 wherein depositing a titanium oxide spacer layer by atomic layer deposition comprises depositing the TiOx by atomic layer deposition while the substrate is heated to a temperature between 100 and 300° C. without the assistance of a plasma and without the assistance of oxygen.

21. The method of claim 16 wherein patterning the DLC layer into a plurality of stripes comprises patterning the DLC layer into a pattern selected from generally radial spokes, generally concentric circular rings and parallel generally straight lines.

22. An imprint mold comprising:
a substrate having a planar surface;
a base layer selected from Cr, Pd, Rh and alloys thereof on the substrate planar surface;
a plurality of pillars of a material selected from a titanium oxide (TiOx), an aluminum oxide (AlOx), HfO₂, a silicon oxide (SiOx), a silicon nitride (SiNx), Si, Mo and Ta, the pillars extending from the base layer and arranged into a pattern selected from generally radial spokes, generally concentric circular rings, and parallel generally straight lines; and
a conformal film of silicon dioxide having a thickness greater than or equal to 0.5 nm and less than or equal to 5 nm on the tops and sidewalls of the pillars and on regions of the base layer between the pillars.

23. The imprint mold according to claim 22 wherein the pillars consist essentially of titanium dioxide.
